(19) United States
(12) Patent Application Publication
(10) Pub. No.: US 2014/0067357 A1
(43) Pub. Date: Mar. 6, 2014

(54) EVENT DRIVEN SIMULATION OF A SYSTEM MODEL

(71) Applicants: Emerson S. Fang, Fermont, CA (US); Ajay M. Rao, San Jose, CA (US)

(72) Inventors: Emerson S. Fang, Fermont, CA (US); Ajay M. Rao, San Jose, CA (US)

(73) Assignee: ADVANCED MICRO DEVICES, INC., Sunnyvale, CA (US)

(21) Appl. No.: 13/601,901

(22) Filed: Aug. 31, 2012

(51) Int. Cl. G06G 7/62

(52) U.S. Cl. 703/17

(57) ABSTRACT

Methods and systems for simulating a system model are provided. The method includes loading into a computing system the system model that includes a plurality of event generating device models and non-event generating device models, scheduling a next event for each of the event generating device models independent of the next event of each other of the device models, advancing time to an earliest of the scheduled next events that is scheduled at a host device, committing the earliest of the scheduled next events, and replacing the earliest of the scheduled next events with a new next event for the host device.

### TECHNICAL FIELD

The technical field relates generally to modeling and simulation environments, and more particularly to event driven simulation of system models.

### BACKGROUND

Computer modeling and simulation of modern mixed signal systems is becoming increasingly complex. For example, modern microprocessors consist of many analog/mixed-signal blocks that perform tasks such as clock synthesis, de-skewing, power supply regulation, and data communication. The advent of light and small form-factor mobile computing devices like smart-phones and tablets has further driven the need to integrate more mixed-signal functions into a single system-on-a-chip (SOC). Through-silicon-via (TSV) 3-D die-stacking technology is enabling tight integration of new devices not normally found in CMOS technology, such as optical components and micro electro-mechanical systems (MEMS) to form a complex mixed-signal system. The increasing complexity of modern integrated circuit manufacturing processes geared primarily towards high-speed digital logic makes design of analog circuits more challenging.

Existing modeling and simulation tools may be slow and often have issues that affect accuracy. For example, VERILOG AMS has an underlying time grid and is therefore not true continuous time based, which can lead to inaccuracy and artifacts. MATLAB/SIMULINK is equation based and is not efficient to represent large systems.

Detailed circuit simulators often have highly complex algorithms that have limited ability to simulate large complex systems. For example, Simulation Program with Integrated Circuit Emphasis (SPICE) has an O(N^{α}) complexity algorithm with respect to the number of elements N, where α>1 and the value of α is dependent on how the sparse matrix structure maintains its sparseness during simulation.

The evolution towards complex systems and the design paradigm shift to algorithmic solutions necessitates capable and powerful mixed-signal modeling and verification solutions.

### SUMMARY OF EMBODIMENTS

Methods and systems for simulating a system model are provided. In some embodiments a method includes loading into a computing system the system model that includes a plurality of event generating device models and non-event generating device models, scheduling a next event for each of the event generating device models independent of the next event of each other of the device models, advancing time to an earliest of the scheduled next events that is scheduled at a host device; committing the earliest of the scheduled next events to define the earliest of the scheduled next events as an occurred event, and replacing the earliest of the scheduled next events with a new next event for the host device.

In some embodiments a non-transitory computer readable medium storing control logic for execution by at least one processor of a computer system is provided. The control logic comprises instructions to load into a computing system a system model that includes a plurality of event generating device models and non-event generating device models, schedule a next event for each of the event generating device models independent of the next event of each other of the device models, advance time to an earliest of the scheduled next events that is scheduled at a host device, commit the earliest of the scheduled next events to define the earliest of the scheduled next events as an occurred event, and replace the earliest of the scheduled next events with a new next event for the host device.

In some embodiments a computer system includes a processor that includes control logic. The control logic is configured to load into the computing system a system model that includes a plurality of event generating device models and non-event generating device models, schedule a next event for each of the event generating device models independent of the next event of each other of the device models, advance time to an earliest of the scheduled next events that is scheduled at a host device, commit the earliest of the scheduled next events to define the earliest of the scheduled next events as an occurred event, and replace the earliest of the scheduled next events with a new next event for the host device.

### BRIEF DESCRIPTION OF THE DRAWINGS

Advantages of the embodiments disclosed herein will be readily appreciated, as the same becomes better understood by reference to the following detailed description when considered in connection with the accompanying drawings wherein:

FIG. 1 is a simplified block diagram of a computing system according to some embodiments;

FIG. 2 is a simplified block diagram of a system model according to some embodiments;

FIG. 3 is a simplified block diagram of a port structure according to some embodiments;

FIG. 4 is a simplified block diagram of an event data structure according to some embodiments;

FIG. 5 is a simplified block diagram of a device layout according to some embodiments;

FIG. 6 is a simplified timeline of scheduled events according to some embodiments;

FIG. 7 is a graphical view of an event value in time according to some embodiments;

FIG. 8A is a simplified block diagram of a system model according to some embodiments;

FIG. 8B is a graphical view of output values of devices of the system model of FIG. 8A according to some embodiments; and

FIG. 9 is a flow diagram illustrating a method of simulating a system model according to some embodiments.

### DETAILED DESCRIPTION

The following detailed description is merely exemplary in nature and is not intended to limit application and uses. As used herein, the word “exemplary” means “serving as an example, instance, or illustration.” Thus, any embodiments described herein as “exemplary” are not necessarily to be construed as preferred or advantageous over other embodiments. All of the embodiments described herein are exemplary embodiments provided to enable persons skilled in the art to make or use the disclosed embodiments and not to limit the scope of the disclosure which is defined by the claims. Furthermore, there is no intention to be bound by any expressed or implied theory presented in the preceding technical field, background, brief summary, the following detailed description or for any particular computer system.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Finally, for the sake of brevity, conventional techniques and components related to computer systems and other functional aspects of a computer system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in the embodiments disclosed herein.

In some embodiments, a unified solution for analog and digital modeling and simulation in a single environment is provided. Other desirable features and characteristics of the disclosed embodiments will become apparent from the subsequent detailed description and the appended claims, taken in conjunction with the accompanying drawings.

In general, an event driven mixed signal modeling and simulation environment is presented. The environment has the ability to encapsulate complex events, has a linear complexity algorithm, and uses a parallel processing capable algorithm. The linear complexity O(N) algorithm means the simulation time of an N-device system is linearly proportional to the sum of the individual constituent device simulation time. The complexity baseline number N is defined as the number of devices that are capable of generating events on output ports. An event may represent various changing conditions of the system, such as a binary logic state change at a low level and or sudden air turbulence affecting the flight of an airplane at a high level. The complexity algorithm and features of the environment contribute to fast and accurate simulation of systems on chip (SOC) and other complex integrated circuits.

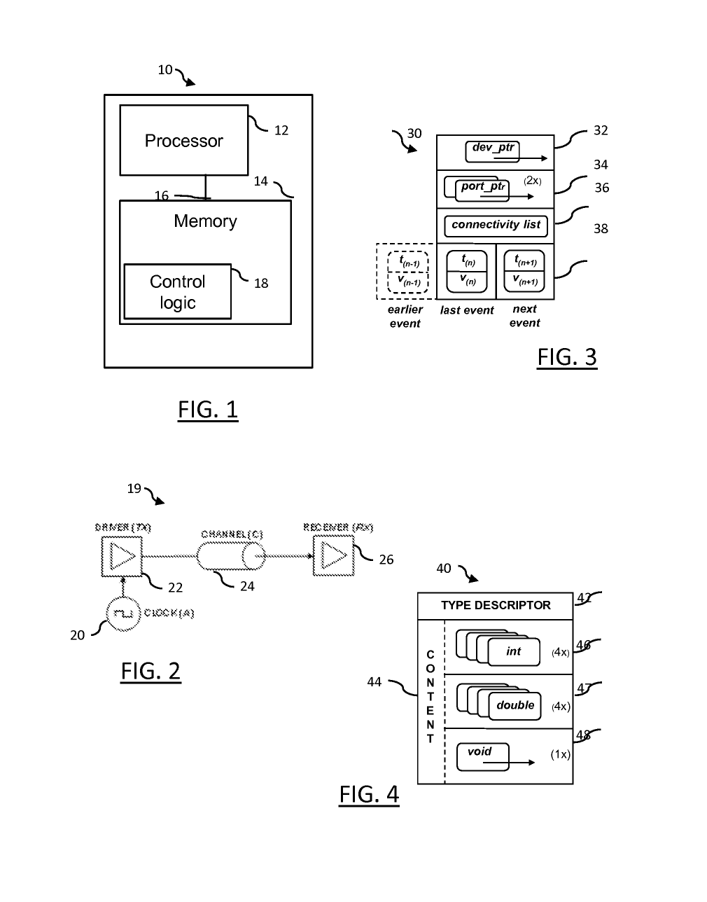

Referring now to FIG. 1, a simplified block diagram of a computing system 10 is illustrated, according to some embodiments. The computing system 10 includes a processor 12, a memory 14 coupled with the processor 12 by an interconnect 16, and a control logic 18. The processor 12 may be a microprocessor, microcontroller, digital signal processor, or any other processor configured to execute software instructions for performing the various tasks of the computing system 10. The memory 14 may be any non-transitory computer readable medium that is capable of storing digital data. For example, the memory 14 may be one or more integrated circuits of static random access memory (SRAM), dynamic random access memory (DRAM), magnetic cassettes, flash memory cards, digital video disks, read only memories (ROMs), and the like. Additionally, the computer readable medium is non-transitory, and therefore is not an electrical signal or the like.

The control logic 18 defines the modeling environment and the simulation of a mixed-signal system. In some embodiments, the control logic 18 is a software program stored in the memory 14 and is written in the C++ programming language with support from open source libraries, such as the Standard Template Library. In general, the control logic 18 defines the component device models of a system, the connections among the device models, and the interactions among the device models.

The device models include a collection of interacting devices, each of which may consist of many sub-devices in a hierarchical manner. In order to attain uniformity in a single framework and to allow smooth interfacing between devices, each device model adheres to port and event protocols. Each of the devices includes at least one port that is connected to a port of another device. The ports include derived and non-derived ports that are arranged in a connectivity tree. Non-derived ports are output ports that are at the root of the connectivity tree and are places of event origination. All other ports in the port connectivity tree are derived. Derived ports do not generate events and serve as conduits for events. Input ports that are downstream or depend from output ports are considered to be driven by the output ports.

Each device model may be associated with one or more routines. For example, a nxt_ routine calculates the next event of the device model at each output port of the device to provide event evolution function based on current input and internal state. An excite_ routine updates the internal state of the device or produces an output event in response to an input change at an input port of the device. A commit_ routine declares the occurrence of an event. The commit_ routine may be executed during an event loop in association with a nxt_ routine or may be associated with an excite_ routine to commit zero-delay events triggered by the excite_ routine. An opt_ routine calculates an output value based on the input value being propagated in for calculating operating condition.

The devices include leaf devices and non-leaf devices. A leaf device generates events on output ports of the leaf device. Non-leaf devices, such as devices that merely encapsulate other devices, do not generate events. To support flexible modeling and fast simulation time, the control logic 18 permits independent modeling approaches for each individual leaf device. In the same modeled system, a high-level behavior model using C++ may be used for one device while another device may be modeled independently using an Simulation Program with Integrated Circuit Emphasis (SPICE) engine. Each device has independent time evolution and an independent time step that may be fixed or variable. For example, with N leaf devices a modeled system may have N unique time evolution schemes.

The control logic 18 preferably includes a SPICE engine that may be used to model a circuit device with tightly coupled groups of circuit elements. For example, an LC voltage-controlled oscillator (VCO) includes tight coupling of elements. A SPICE device is a circuit device that is modeled in SPICE and may be configured to generate an event each time a continuous time waveform changes by a certain amount, such as a defined change in output voltage. New devices may be added using specialized algorithms as long as the port and event protocols of the environment are observed. Furthermore, a class (j_tbl_) is provided to support storage of 0-, 1- and 2-dimensional tables in memory for supporting table-driven models. The class has functions that allow for indexed, direct and reverse data lookup. Linear interpolation is used to define values between points in the table and partial derivatives may be generated automatically.

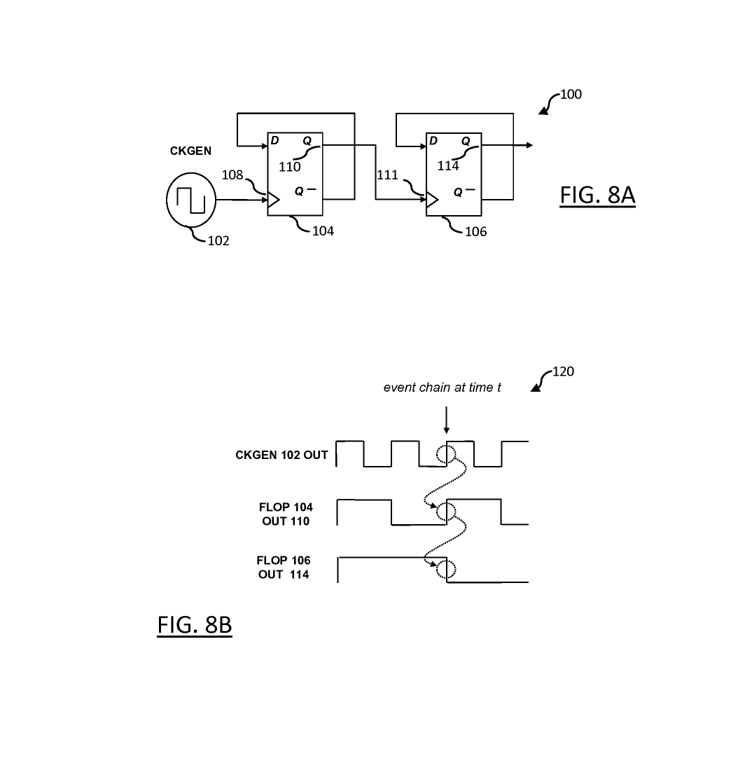

The control logic 18 includes a device model library. Leaf devices in the device model library include various parameters that tweak the behavior of the leaf device. For example, it is possible to select a rising or falling clock edge as an event that defines when to sample incoming data in a flip-flop leaf device model, as will be described below with reference to FIGS. 8A and 8B. To allow quick configuration of each leaf device model, a parameter definition and duplication system forms part of the infrastructure of the environment. Parameters may carry various kinds of values, such as Boolean, integer, double, character strings, and j_tbl_ objects.

Referring now to FIG. 2, and with continued reference to FIG. 1, an exemplary modeled system 19 defined by the control logic 18 is illustrated. In the example provided, a clock device 20 drives a transmitter device 22 through a communication channel device 24 to be received at a receiver 26. Clock device 20 generates an edge event every period T_{A} and the transmitter device 22 is stimulated by the clock device 20 to generate a data bit for each edge event. In the example provided, the detailed physical model of the clock device 20 is a phase-locked loop (PLL) circuit whose output edge times deviate from the T_{A} grid due to sensitivity to supply and intrinsic device noise, and additional factors such as spread-spectrum clocking (SSC). It should be appreciated that the control logic 18 permits the abstract model of the clock 20 to be replaced by a detailed physical model with no changes to the other device models as long as both have the same output port and generate the same output event type. Channel device 24 is a delay buffer that represents channel latency, and the receiver device 26 performs the desired logic operation on the received bits. The channel device 24 is represented by a generic linear time-invariant (LTI) device based on step response.

Referring now to FIG. 3 and with continued reference to FIG. 1, an example of a port 30 is illustrated. The port 30 may be associated with various functions that define activity at the port 30 when the port 30 is excited or evaluated in the event loop. The exemplary port 30 includes a device pointer 32, at least one source pointer 34, a connectivity list 36, and an event queue 38. The device pointer 32 points to the home device hosting the port. Derived ports contain two source pointers 34. The first source pointer 34 points to the port directly driving the derived port and the second source pointer 34 points to the non-derived port at the root of the connectivity tree. The source pointers 34 are null pointers when the port is a non-derived port. The connectivity list 36 is a list of ports that are driven by the port 30.

The event queue 38 is empty for a derived port and includes at least two indicators of events for a non-derived port. For example, an event queue 38 for a non-derived port contains the last event and the next event. The last event is the most recent event that occurred or was committed on the port 30 while the next event is the event to occur next on the port 30. An event is committed or made current when the commit_ routine is executed during the event loop or after an excitation. In some embodiments, the event queue 38 stores additional past events. The next pending events at the event queue 38 of output ports are considered to have not yet occurred until they are committed by the control logic 18. Each time through the event loop, the control logic 18 picks the next event in time to commit. A committed next pending event is then placed in the last event portion of the event queue 38 and a new next pending event is calculated and placed in the next event portion of the output port by the control logic 18.

Referring now to FIG. 4, an event value structure 40 is illustrated. The event value structure 40 includes a type field 42 and a content field 44. The type field 42 identifies the type of event. The types include integer type, real type, complex type, bus type, and custom type. Integer, real, complex, and bus types are known to those skilled in the art. The custom event type represents all other events. The event content field 44 in the example provided includes four integers 46, four doubles 47, and a pointer 48. The custom event uses the first integer in the content field 44 as an event identifier. The content field 44 may contain information such as a 128-bit bus value or a position in 3-D space. The pointer field 48 may be used to link to storage space for representing complex events that are too large for the content field 44, such as air turbulence. For example, an LTI step-response device (LTISTEP) in the standard device library of the environment may be represented by the event value structure 40. Properties of a digital transmission line may be captured by measuring the step response in the time domain. The output of the transmission line to digital stimulation (i.e. input steps) can be obtained through linear scaling and superposition of the step responses. The nominal step response is stored in a table and is accessed via the event content pointer field 48. The starting and ending table index, scaling value, and other table modification parameters are passed via the four integer 46 and four double 47 event content fields. Transmit-driver non-linear effects may be modeled using a non-linear scaling coefficient or simply by letting the event content pointer 48 point to a new step response table when the transmitter transitions from one piecewise linear region into another. The custom event extension combined with a standard device port 30 permits end users to model complex devices compactly and efficiently.

The control logic 18 schedules and commits events on a continuous time scale. For example, an event may be scheduled at any point on the time scale limited only by the floating number precision of the machine. Events may represent any communication between devices, such as a clock edge event of the clock device 20. A device may generate an event on its own or in response to an event at an input port. Additionally, state events may be scheduled that allow a device to advance time and update an internal state of the device without generating output events. The leaf devices may set conditions for each port that define what constitutes an event. For example, a SPICE device produces a continuous time waveform that may generate an event each time an output voltage changes by a certain specified voltage.

The control logic 18 initially calculates a next scheduled event for each device and then commits the pending scheduled events in an event loop. When committing the next pending event, the control logic 18 evaluates the ports that are driven by the host port of the currently committed event to determine if the driven ports are to be updated. For example, a device may be excited by a committed event by associating an excitation routine to an input port that is driven by an output port associated with the committed event. Alternatively, each device may check for an event that has occurred at an input of the device and respond appropriately during the time evolution of the device in the event loop.

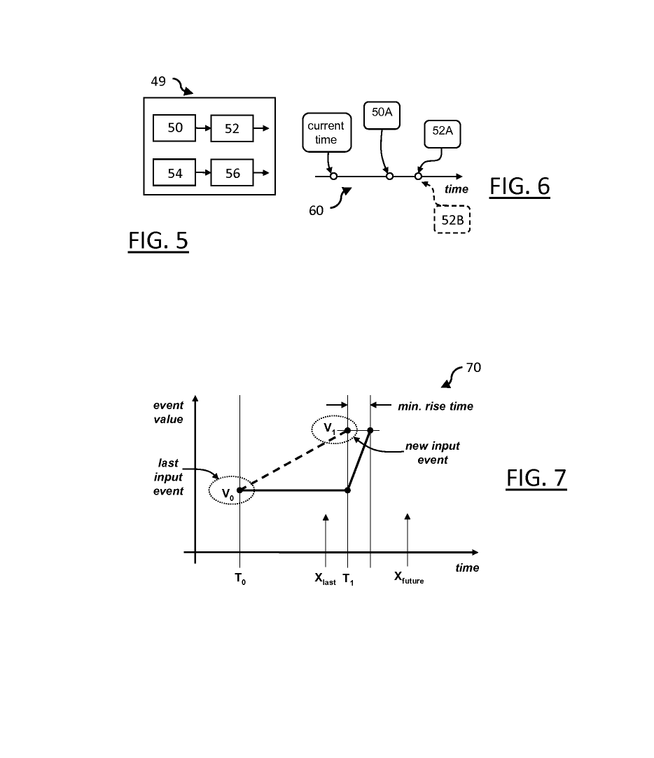

Referring now to FIGS. 5 and 6, a device layout 49 illustrates an example of devices 50, 52, 54, 56 and event dependence among the devices 50, 52, 54, 56. The events of device 50 and device 54 are not affected by the events of any other device. The events of device 52 may be updated based on the events of device 50 and the events of device 56 may be updated based on the events of device 54. A timeline 60 illustrates a scheduled event 50A for device 50 and a scheduled event 52A for device 52. Device 52 calculates the next event 52A and places the event 52A at the output port of the device 52 without knowing the event 50A is to occur. Once event 50A is committed in the event loop, device 52 re-evaluates whether event 52A is still valid. For example, the input port of device 52 may have an excite_ routine attached to indicate that the pending events of the device 52 should be evaluated. If the event 52A is to be updated, the pending event 52A is removed and a new event 52B for the device 52 is determined and placed. Device 52 stores the past state that it used to calculate the original event 52A, and may therefore go back to that past state to evaluate the new event 52B. Devices 54 and 56 have no connections to device 50 and events for devices 54, 56 are not affected by the occurrence of event 50A. Accordingly, efficient synchronization is achieved and recalculation of events is limited.

Referring now to FIG. 7, a graph 70 illustrates an event value over time for a SPICE device. The node voltages and branch currents of SPICE devices are retained to promote event synchronization. The last-event state is Xₗₐₛₜ and the calculated future state is X_{future}. The graph 70 illustrates the process the SPICE engine uses to smooth out discrete input events into a continuous waveform. The dotted-line trace is one segment of a piece-wise linear waveform that a stand-alone SPICE simulator typically uses as input. Because the new input event is not known to the receiving device's SPICE engine after the engine declared Xₗₐₛₜ and calculated X_{future}, the solid-line trace is a best approximation. In some embodiments, to avoid a sudden jump at time T₁, a minimum rise time is enforced in delaying the effective time the input will reach the new value of V₁. The input change will likely cause a re-evaluation of X_{future}. The minimum rise time parameter of the device may be set in the input netlist, as will be appreciated by those skilled in the art.

Referring now to FIGS. 8A and 8B, a model 100 of a ripple clock divider system illustrates instantaneous events. Instantaneous events are common in digital simulations and are handled through the excitation mechanism. To maintain causality at zero-delay, the excitation routine places a pending event that occurs at the same time as the excitation event. Given an event excitation does not occur until the event is committed, the sequence of excite and commit promotes the occurrence of cause and effect in order with no time delay. FIG. 8A illustrates a model 100 of the ripple clock divider. The model 100 includes a clock generator (CKGEN) 102, a first flop 104, and a second flop 106. CKGEN 102 drives a rising edge-triggered clock input port 108 of the toggle flip-flop 104. An output 110 of flop 104 drives a rising edge-triggered input port 111 of the toggle flip-flop 106. The second flop 106 includes an output port 114 whose value may be stored or viewed as an output of the ripple clock divider system model 100.

FIG. 8B is a graph 120 illustrating event occurrences at output ports of the devices 102, 104, 106 in time. Each edge of the CKGEN output constitutes an event. The inputs 108, 111 each have excite_ and commit_ functions attached. In the example provided, the excite_ function responds to rising edge events by placing an event at the respective output ports 110, 114 and does not respond to falling edge events. The scheduled time of the event placed at the output port 110, 114 is the same time as the input excitation. The commit_ routine is then called to declare the occurrence of the output event at the output ports 110, 114. The commit_ declaration at the first flop 104 excites the input 111 of the second flop 106 to permit events to ripple in zero time. For example, at time t a rising edge of the CKGEN 102 excites the input 108 of the flop 104 to cause a rising edge event at the output 110 of the flop 104. The rising edge event at the output 110 of the flop 104 excites the input 111 of the flop 106 to cause a change of output to be committed at the output port 114.

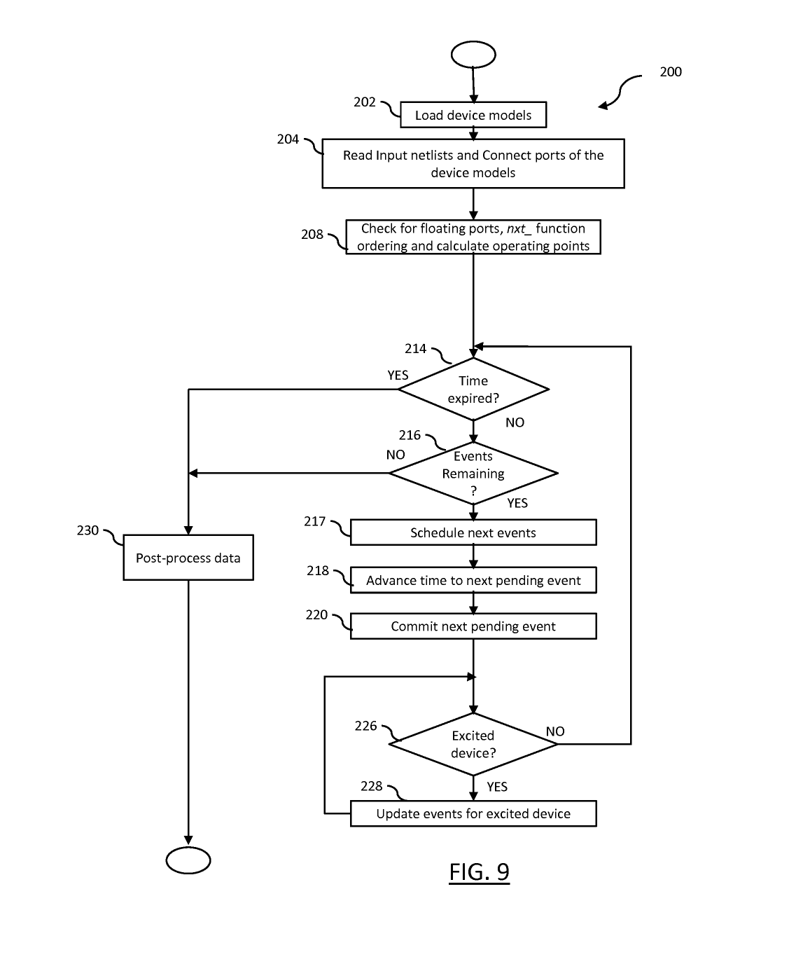

Referring now to FIG. 9, a method 200 of simulating a system model in a computing system is illustrated. At step 202 device models are loaded for event generating leaf devices and non-event generating devices. The device models include conditions of the devices that define events, such as a rising or falling edge of a clock device. The input netlists are read and the device models are connected in a connectivity tree at ports of the devices in step 204. A floating port check by the netlist, nxt_ function ordering and operating point calculations take place in step 208, as will be appreciated by those skilled in the art.

Steps 214 and 216 determine whether the simulation is to continue or to end based on simulation end characteristics. The simulation end characteristics include an amount of time passed and a lack of remaining events to process. For example, step 214 determines whether a time threshold has been exceeded, such as a maximum simulation time set by the user of the simulation environment. When the time has not exceeded the threshold the method proceeds to step 216 to determine if there are pending events remaining.

When there are remaining pending events the method proceeds to step 217 where next pending events are scheduled for each event generating output port. To schedule a next pending event, the method simulates each device until an event is generated for each event generating output port of the device. The generated event is then placed at the respective output port with a scheduled time to be committed. The events are scheduled on a continuous time scale and stored at the event generating output ports. For example, the control logic 18 may execute a nxt_ routine to schedule the next event.

Time is advanced to the time of the next pending scheduled event at step 218. When two or more events occur at the same time, they are handled in a FIFO posting order. Therefore, the order will vary based on the arrangement of the devices in the model. At step 220 the next scheduled pending event is committed and is considered to have occurred. For example, the control logic 18 may execute a commit_ routine to commit the event. Output values may be captured when each event is committed by use of custom functions attached to port objects. The functions may be used, for example, to write standard waveform format files such as VCD, FSDB, and TR0.

At step 226 the control logic 18 determines whether ports driven by the output ports of the host device of the currently committed event are to be updated based on the currently committed event. For example, a device driven by the output port of the host device may contain an excite_ routine that indicates the events of the device that includes the excite_ routine are to be updated. When there is a remaining excited device the control logic 18 updates the events of the excited device at step 228. For example, the control logic 18 may replace the next scheduled event of the excited device with a new scheduled event based on new input at the excited device. When no excited devices remain, the method returns to step 214.

When the simulation time has expired or no events remain the method proceeds to step 230 where post-processing of data from the simulation is executed. For example, data gathered during the simulation may be output in the form of a histogram.

A data structure representative of the computer system 10 and/or portions thereof included on a computer readable storage medium may be a database or other data structure which can be read by a program and used, directly or indirectly, to fabricate the hardware comprising the computer system 10. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the computer system 10. The netlist may then be placed and routed to produce a data set describing geometric shapes to be applied to masks. The masks may then be used in various semiconductor fabrication steps to produce a semiconductor circuit or circuits corresponding to the computer system 10. Alternatively, the database on the computer readable storage medium may be the netlist (with or without the synthesis library) or the data set, as desired, or Graphic Data System (GDS) II data.

The method illustrated in FIG. 9 may be governed by instructions that are stored in a non-transitory computer readable storage medium and that are executed by at least one processor of the computer system 10. Each of the operations shown in FIG. 9 may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

The provided modeling and simulation environment has several beneficial attributes that promote fast analysis of complex mixed-signal systems. Accuracy and simulation time may be balanced by creating leaf devices that vary in detail. Furthermore, the inherent structure of the environment allows for parallel computation during various steps of a simulation. For instance, system next-event calculation is done by requesting all devices in the system that are capable of generating events to compute their individual next-event time based on their input values and states and post them to a queue. This step can be executed in parallel for all the devices in the model because they are independent of each other during this time.

Embodiments have been described herein in an illustrative manner, and it is to be understood that the terminology which has been used is intended to be in the nature of words of description rather than of limitation. Obviously, many modifications and variations are possible in light of the above teachings. Various implementations may be practiced otherwise than as specifically described herein, but are within the scope of the appended claims.

What is claimed is:

1. A method comprising:
loading into a computing system a system model that includes a plurality of event generating device models and non-event generating device models;
scheduling a next event for each of the event generating device models independent of the next event of each other of the device models;
advancing time to an earliest of the scheduled next events that is scheduled at a host device;
committing the earliest of the scheduled next events to define the earliest of the scheduled next events as an occurred event; and
replacing the earliest of the scheduled next events with a new next event for the host device.

2. The method of claim 1 further including determining whether the scheduled events are to be updated based on the committed event and updating the scheduled events that are to be updated based on the committed event.

3. The method of claim 1 further including defining a condition of each event generating device that defines an event.

4. The method of claim 1 wherein loading the modeled system includes loading the device models that each have at least one port and connecting the device models with each other at the ports.

5. The method of claim 1 wherein scheduling the next event for each of the event generating device models includes scheduling the next event on a continuous time scale.

6. The method of claim 1 wherein scheduling the next event for each of the event generating device models includes generating the scheduled next events and storing each next event at an output port of the respective device model.

7. The method of claim 6 wherein replacing the earliest of the scheduled next events includes storing the earliest of the scheduled next events as a last scheduled event at the output port of the respective device model.

8. The method of claim 6 further including exciting an input port of an excited device that is driven by the output port of the device model for which the scheduled next event was committed.

9. The method of claim 8 further including scheduling a new next event for the excited device and storing the new next event of the excited device at an output port of the excited device.

10. The method of claim 9 wherein scheduling the new next event of the excited device includes scheduling the new next event at the same scheduled time as the committed event for simulating zero delay events.

11. The method of claim 1 further including repeating an event loop until a simulation end characteristic is met, wherein the event loop includes scheduling the next events, advancing time to the earliest of the scheduled next events, committing the earliest of the scheduled next events, and replacing the earliest of the scheduled next events.

12. The method of claim 1 further including loading a device that includes a Simulation Program with Integrated Circuit Emphasis (SPICE) model, and further including defining a condition of the SPICE model that generates an event.

13. A non-transitory computer readable medium storing control logic for execution by at least one processor of a computer system, the control logic comprising instructions to:
load into a computing system a system model that includes a plurality of event generating device models and non-event generating device models;
schedule a next event for each of the event generating device models independent of the next event of each other of the device models;
advance time to an earliest of the scheduled next events that is scheduled at a host device;
commit the earliest of the scheduled next events to define the earliest of the scheduled next events as an occurred event; and
replace the earliest of the scheduled next events with a new next event for the host device.

14. The computer readable medium of claim 13 wherein the control logic includes instructions to determine whether the scheduled events are to be updated based on the committed event and update the scheduled events that are to be updated based on the committed event.

15. The computer readable medium of claim 13 wherein the control logic includes instructions to load the device models that each have at least one port and connect the device models with each other at the ports to load the modeled system.

16. The computer readable medium of claim 13 wherein the control logic includes instructions to schedule the next event on a continuous time scale.

17. The computer readable medium of claim 13 wherein the control logic includes instructions to generate the scheduled next events and store each next event at an output port of the respective device model.

18. The computer readable medium of claim 17 wherein the control logic includes instructions to store the earliest of the scheduled next events as a last scheduled event at the output port of the respective device model when replacing the earliest of the scheduled next events.

19. The computer readable medium of claim 17 wherein the control logic includes instructions to excite an input port of an excited device that is connected downstream of the output port of the device model for which the scheduled next event was committed and to schedule a new next event for the excited device and store the new next event of the excited device at an output port of the excited device.

20. The computer readable medium of claim 19 wherein the control logic includes instructions to schedule the new next event of the excited device at the same scheduled time as the committed event for simulating zero delay events.

21. The computer readable medium of claim 13 wherein the control logic includes instructions to repeat an event loop until a simulation end characteristic is met, wherein the event loop includes scheduling the next events, advancing time to the earliest of the scheduled next events, committing the earliest of the scheduled next events, and replacing the earliest of the scheduled next events.

22. A computing system comprising:
a processor including control logic configured to:
load into the computing system a system model that includes a plurality of event generating device models and non-event generating device models;
schedule a next event for each of the event generating device models independent of the next event of each other of the device models;
advance time to an earliest of the scheduled next events that is scheduled at a host device;
commit the earliest of the scheduled next events to define the earliest of the scheduled next events as an occurred event; and
replace the earliest of the scheduled next events with a new next event for the host device.

23. The computing system of claim 22 wherein the control logic is further configured to determine whether the scheduled events are to be updated based on the committed event and to update the scheduled events that are to be updated based on the committed event.

24. The computing system of claim 22 wherein the control logic is configured to load the device models that each have at least one port and connect the device models with each other at the ports to load the modeled system.

25. The computing system of claim 22 wherein the control logic is further configured to schedule the next event on a continuous time scale.

26. The computing system of claim 22 wherein the control logic is further configured to generate the scheduled next events and store each next event at an output port of the respective device model.

27. The computing system of claim 26 wherein the control logic is further configured to store the earliest of the scheduled next events as a last scheduled event at the output port of the respective device model when replacing the earliest of the scheduled next events.

28. The computing system of claim 26 wherein the control logic is further configured to excite an input port of an excited device that is connected downstream of the output port of the device model for which the scheduled next event was committed and to schedule a new next event for the excited device and store the new next event of the excited device at an output port of the excited device.

29. The computing system of claim 28 wherein the control logic is further configured to schedule the new next event of the excited device at the same scheduled time as the committed event for simulating zero delay events.

30. The computing system of claim 22 wherein the control logic is further configured to repeat an event loop until a simulation end characteristic is met, wherein the event loop includes scheduling the next events, advancing time to the earliest of the scheduled next events, committing the earliest of the scheduled next events, and replacing the earliest of the scheduled next events.
